(19) United States
(12) Patent Application Publication
(10) Pub. No.: US 2026/0305863 A1
(43) Pub. Date: Oct. 8, 2026

(54) GUIDE STRUCTURE FOR HAND DRIP COFFEE

(71) Applicant: C Inc., Cheongju-si (KR)

(72) Inventor: Jee-young OH, Cheongju-si (KR)

(21) Appl. No.: 18/998,468

(22) PCT Filed: May 3, 2023
(86) PCT No.: PCT/KR2023/006051

§ 371 Date: Feb. 21, 2025

(30) Foreign Application Priority Data
Jul. 26, 2022 (KR) 10-2022-0092168

(51) Int. Cl. A47J 31/06; A47J 31/02

(52) U.S. Cl. CPC A47J 31/0631; A47J 31/02; A47J 2031/0694

(57) ABSTRACT

The present invention provides a guide structure for a hand drip coffee. The present invention relates to application of a ring tool member having a rib function to a drip filter and, through this, is to prevent the drip filter from being adsorbed to a rib when water is poured into a coffee powder and generate a natural whirlpool while slowing down the speed of water when the water passes through a dripper in which the drip filter is installed. Through this, not only the taste of the extracted coffee can be stably maintained, but also ordinary people can also extract coffee having a uniform taste like experts regardless of a user's skill level.

### TECHNICAL FIELD

The present invention relates to a guide structure for hand drip coffee, and more specifically, to a guide structure for hand drip coffee which applies a ring tool member having a rib function to a drip filter to maintain an air flow space between a dripper and a drip filter and generate a vortex inside the drip filter during coffee hand dripping, thus stably maintaining the taste of the extracted coffee and allowing ordinary people to extract coffee having a uniform taste like experts regardless of a user's skill level.

### BACKGROUND ART

In general, a dripper is used when extracting coffee by placing coffee powder into a drip filter and pouring water over the coffee powder.

In other words, with a pot positioned below, the dripper is placed on top of the pot, a drip filter is inserted inside the dripper, and a measured amount of coffee powder is placed in the drip filter.

Subsequently, when hot water is slowly poured over the coffee powder from the center outward, bubbles form the coffee grounds occurs to achieve the coffee extraction. The extracted coffee then passes through the drip filter and flows down into the pot.

Meanwhile, upon examining the interior of the dripper, the slanted wall surface of the dripper has elongated convex protrusions arranged at regular intervals. The protrusions are referred to as “ribs” since resembling ribs.

The ribs, formed as grooves or protrusions on the inner wall of the dripper in a diagonal or straight direction, create a space that allows air to pass between the drip filter and the dripper, facilitating air circulation and creating a passage for water, thereby allowing water to flow smoothly.

Meanwhile, for effective coffee extraction, the extraction process along the side of the dripper should be swift. To achieve the swift extraction, the side of the paper-based drip filter must remain separated from the dripper's inner wall.

However, there are several problems. When placing a drip filter inside the dripper for coffee extraction, depending on users, the drip filter does not properly adsorbed to the ribs and water may concentrate in a single spot, so unskilled persons may not extract coffee with a consistent taste.

### DISCLOSURE

### Technical Problem

Accordingly, the present invention has been made in view of the above-mentioned problems occurring in the related art, and it is an object of the present invention to provide a guide structure for hand drip coffee, which applies a ring tool member having a rib function to a drip filter to prevent a drip filter from adsorbing to ribs and to delay the speed and create a natural vortex when water passes through a dripper on which a drip filter is mounted, thus stably maintaining the taste of the extracted coffee and allowing ordinary people to extract coffee having a uniform taste like experts regardless of a user's skill level.

### Technical Solution

To accomplish the above-mentioned objects, according to the present invention, there is provided a guide structure for hand drip coffee which is a circular or elliptical ring tool member stacked on a drip filter inserted into a dripper placed on top of a pot, where coffee powder is introduced therein, including: a mounting-type fixing ring positioned over the top of the dripper; and a water flow guiding band extending from the mounting-type fixing ring, and depending on the weight of the introduced coffee powder, unfolding in a stepped form and adhering spirally to the inner surface of the drip filter.

Moreover, a sagging weight is formed at the inner center of the water flow guiding band to guide unfolding of the water flow guiding band.

Furthermore, the water flow guiding band unfolds in a stepped form by a cutting line continuously formed in a concentric, regular curved shape inside the mounting-type fixing ring and provides a water flow passage being in close contact with the inner surface of the drip filter.

Additionally, the water flow guiding band unfolds in a stepped form by the cutting line continuously formed in an irregular wave-shaped curve to be cut in a wave-shaped or sawtooth-shaped extension line and provides a water flow passage being in partial contact with the inner surface of the drip filter.

In addition, a measuring part is formed on the surface of the water flow guiding band to measure the amount of coffee powder introduced into the drip filter without using a scale.

Moreover, the measuring part is numerical indicators or measurement units.

Furthermore, the water flow guiding band is made of any one of paper and plastic material with a predetermined thickness, is continuously cut in a spiral shape, and has a coil shape maintaining a consistent width when unfolded in a stepped form.

Additionally, at least one adhesive band is formed in the diameter direction of the water flow guiding band to prevent unraveling before the stepped unfolding is performed.

In addition, the adhesive band is adhered and fixed in an intersecting manner in the horizontal direction to the vertical direction of the water flow guiding band.

Moreover, the adhesive band is a starch-based tape that loses adhesion under the weight of the introduced coffee powder.

Furthermore, the adhesive band is an elastic silicone thread that stretches when the water flow guiding band unfolds in the stepped form under the weight of the introduced coffee powder.

Additionally, the mounting-type fixing ring includes a horizontal band intersecting a circular frame as a basic frame, and the horizontal band has anti-unraveling fixing pins protruding on the lower portion of the horizontal band.

In addition, the water flow guiding band includes pin coupling holes corresponding to the anti-unraveling fixing pins protruding from the lower portion of the horizontal band.

### Advantageous Effect

According to an embodiment of this invention, the guide structure for hand drip coffee applies a ring tool member having a rib function to a drip filter to prevent a drip filter from adsorbing to ribs and to delay the speed and create a natural vortex when water passes through a dripper on which a drip filter is mounted, thus stably maintaining the taste of the extracted coffee and allowing ordinary people to extract coffee having a uniform taste like experts regardless of a user's skill level.

The effects of the present invention are not limited to the above-mentioned effects and further effects not described above will be clearly understood by those skilled in the art.

### DESCRIPTION OF DRAWINGS

FIG. 1 is a perspective view of a coffee hand drip structure with a guide structure (ring tool member) applied according to a first embodiment of the present invention.

FIG. 2 is a perspective view illustrating the guide structure (ring tool member) before being unfolded, in which a cutting line continuously formed on the inner side of a mounting-type fixing ring is formed in a regular curved shape with a concentric circle.

FIG. 3 is a plan view corresponding to FIG. 2 of the first embodiment of the present invention.

FIG. 4 is a perspective view illustrating a state which coffee is hand-dripped using the guide structure (ring tool member) according to the first embodiment of the present invention.

FIG. 5 is a photograph illustrating the state which coffee is hand-dripped using the guide structure (ring tool member) according to the first embodiment of the present invention.

FIG. 6 is a structural diagram of a coffee hand drip guide according to a second embodiment of the present invention, in which a cutting line continuously formed on the inner side of a mounting-type fixing ring is formed in an irregular wave-shaped curve to be cut in a wave-shaped or sawtooth-shaped extension line.

FIG. 7 is an enlarged perspective view of the guide structure (ring tool member) in FIG. 6 according to the second embodiment of the present invention.

FIG. 8 is an enlarged plan view of the guide structure (ring tool member) in FIG. 6 according to the second embodiment of the present invention.

FIG. 9 is a schematic plan view of a guide structure (ring tool member) to which an adhesive band is applied, according to a third embodiment of the present invention.

FIG. 10 is a view illustrating the guide structure (ring tool member) having the adhesive band is applied according to the third embodiment of the present invention is formed in a stepped unfolded state.

FIG. 11 is a perspective view of a guide structure (ring tool member) to which a pin coupling hole is applied according to a fourth embodiment of the present invention.

FIG. 12 is a schematic exploded sectional view illustrating a state in which a fixing pin of a horizontal band is coupled to the pin coupling hole of a water flow guiding band according to the fourth embodiment of the present invention.

### MODE FOR INVENTION

Hereinafter, embodiments of the present invention will be described with reference to the accompanying drawings.

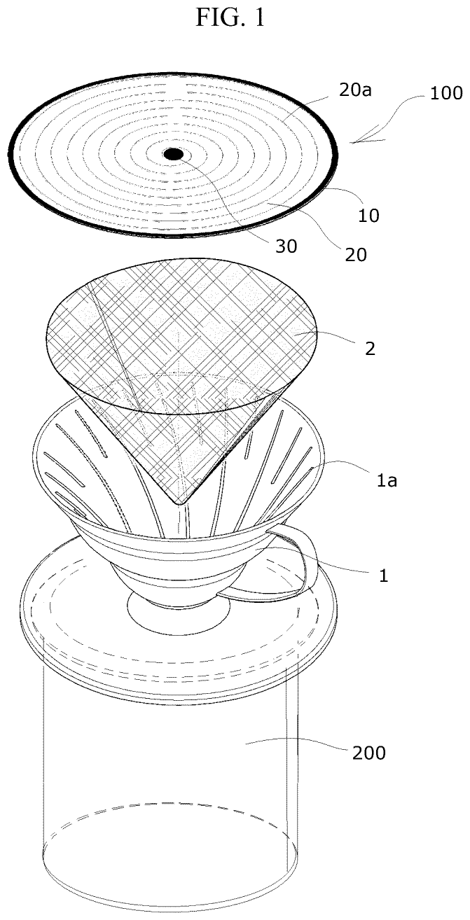

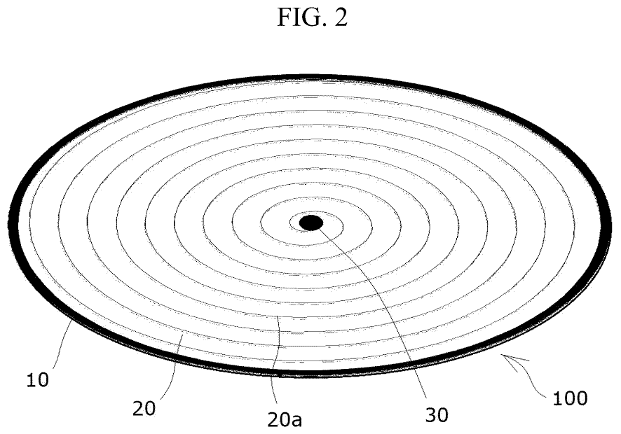

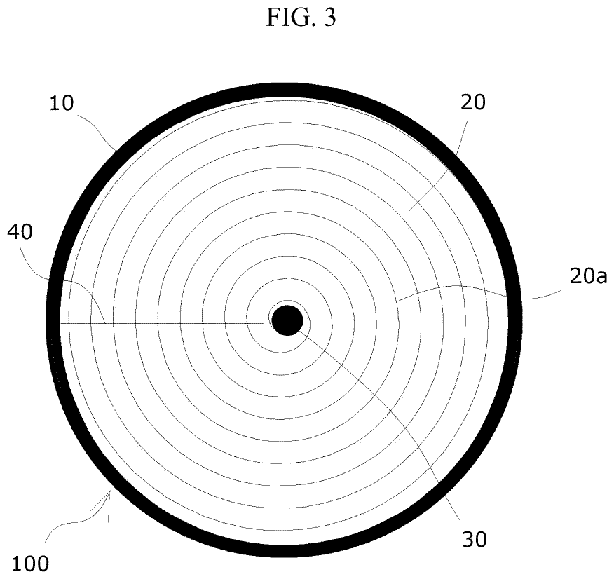

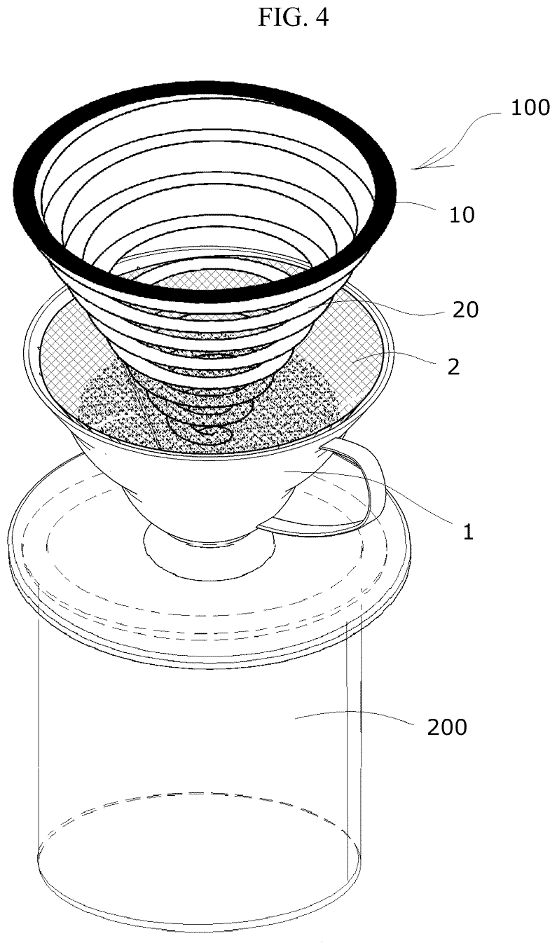

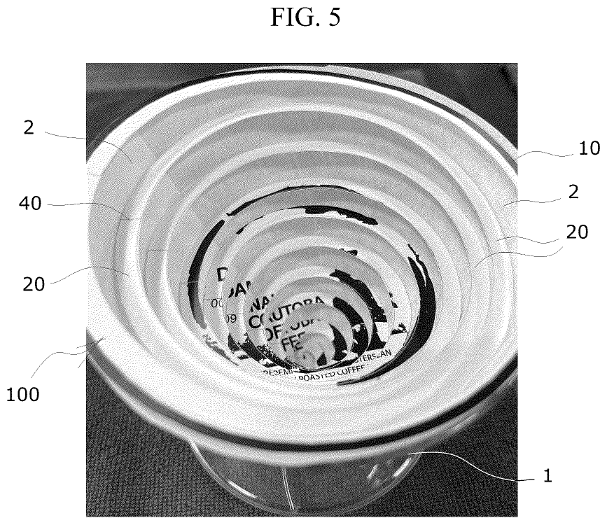

FIG. 1 is a perspective view of a coffee hand drip structure with a guide structure (ring tool member) applied according to a first embodiment of the present invention, FIG. 2 is a perspective view illustrating the guide structure (ring tool member) before being unfolded, in which a cutting line continuously formed on the inner side of a mounting-type fixing ring is formed in a regular curved shape with a concentric circle, FIG. 3 is a plan view corresponding to FIG. 2 of the first embodiment of the present invention, FIG. 4 is a perspective view illustrating a state which coffee is hand-dripped using the guide structure (ring tool member) according to the first embodiment of the present invention, and FIG. 5 is a photograph illustrating the state which coffee is hand-dripped using the guide structure (ring tool member) according to the first embodiment of the present invention.

Referring to FIGS. 1 to 5, the guide structure for hand drip coffee according to the first embodiment of the present invention is a circular or elliptical ring tool member 100 stacked on a drip filter 2 inserted into a dripper 1 placed on top of a pot 200, where coffee powder is introduced therein. the guide structure for hand drip coffee includes a mounting-type fixing ring 10, a water flow guiding band 20, and/or a sagging weight 30 and a measuring part 40.

The mounting-type fixing ring 10 is positioned over the top of the dripper 1.

The water flow guiding band 20 extends from the mounting-type fixing ring 10, and depending on the weight of the introduced coffee powder, unfolds in a stepped form and adheres spirally to the inner surface of the drip filter 2.

That is, the water flow guiding band 20 is made of paper or plastic material with a predetermined thickness and has a spiral cutting line 20a, which is continuously cut in a spiral form, so is separated into a narrow continuous band and has a coil shape with a consistent width when unfolded in the stepped form.

The sagging weight 30 is formed at the inner center of the water flow guiding band 20, guiding the stable unfolding of the water flow guiding band 20.

The measuring part 40 is marked on the surface of the water flow guiding band 20 to measure the amount of coffee powder introduced into the drip filter 2 without using a scale. Accordingly, the measuring part 40 may be numbers indicating measurement scales or measurement units.

As illustrated in FIGS. 1 to 5, the guide structure for hand drip coffee according to the embodiment of the present invention is used by first preparing the pot 200 at the bottom, placing the dripper 1 on top of the pot 200, inserting the drip filter 2 inside the dripper 1, and then positioning the ring tool member 100 over the top of the dripper 1.

In other words, the mounting-type fixing ring 10 included in the ring tool member 100 is installed inside the drip filter 2 laid inside the dripper 1. As described above, the water flow guiding band 20 spirally separated, due to the cutting line 20a continuously cut while maintaining the narrow width inward from the mounting-type fixing ring 10, unfolds, and then, a predetermined amount of ground coffee power is put inside the drip filter 2.

Since the measuring part 40 is marked on the water flow guiding band 20, the input amount of coffee powder can be adjusted through the measuring part 40.

As the water flow guiding band 20 adheres spirally to the drip filter 2 while unfolding in the stepped form depending on the weight of the coffee powder. In this instance, an air flow space is maintained between ribs la formed on the inner wall of the dripper 1 and the drip filter 2.

Thereafter, when hot water is poured gradually from the center outward over the coffee power placed on the water flow guiding band 20, the water contacts the coffee powder. Then, a natural vortex (whirlpool) is generated by the water flow guiding band 20 spirally contacting the drip filter 2 while unfolding in the stepped form, thus allowing water to be evenly distributed over the coffee powder and extracting coffee with a consistent taste even if the drip filter 2 does not adhere to the ribs of the dripper 1.

That is, in a state in which the downward movement speed of the water supplied to the coffee powder is delayed by the the water flow guiding band 20 unfolding in the stepped form, the water contacts the drip filter 2. Accordingly, the ‘blooming’ process where bubbles are generated from the coffee powder can be stabilized.

The extracted coffee passes through the drip filter 2 mounted in the dripper 1 at a slowed rate before reaching the pot, allowing sufficient contact time between the supplied water and the coffee powder to ensure smooth extraction. Thus, coffee with a consistent taste can be extracted regardless of the user's level of experience.

In the embodiment of the present invention described above, the cutting line 20a continuously formed on the inner side of the mounting-type fixing ring 10, which is included in the ring tool member 100 and mounted on top of the dripper 1 is formed in a regular curved shape with a concentric circle, thus allowing the cut section of the water flow guiding band 20 continuously cut with the narrow width inside the mounting-type fixing ring 10 to maintain in close contact with the inner surface of the drip filter 2 laid inside the dripper 1. In this case, the water flow guiding band can guide a spiral water flow to prevent vertical downward flow along the drip filter 2, thus producing a rich and deep taste of high-quality drip coffee.

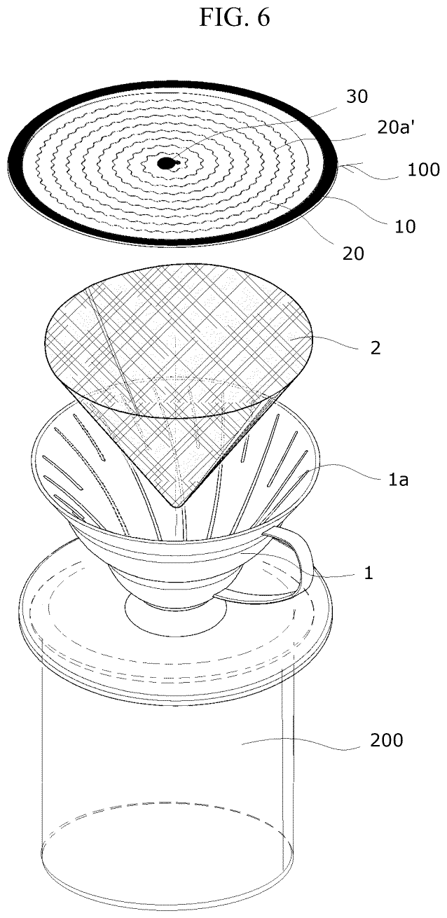

FIG. 6 is a structural diagram of a coffee hand drip guide according to a second embodiment of the present invention, in which a cutting line continuously formed on the inner side of a mounting-type fixing ring is formed in an irregular wave-shaped curve to be cut in a wave-shaped or sawtooth-shaped extension line.

In this embodiment, the water flow guiding band 20, which is in partial contact with the inner surface of the drip filter 2 in the irregular wave curve, provides a spiral water flow due to the inclined continuous band and allows a vertical downward water flow along the drip filter 2 through a section, which is not in contact with the drip filter 2, due to the irregular wave-shaped curve. Consequently, applying the second embodiment results in a milder coffee flavor.

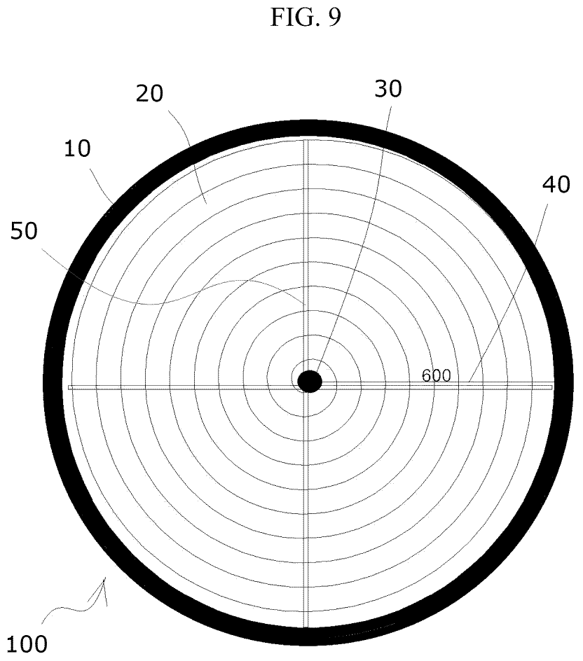

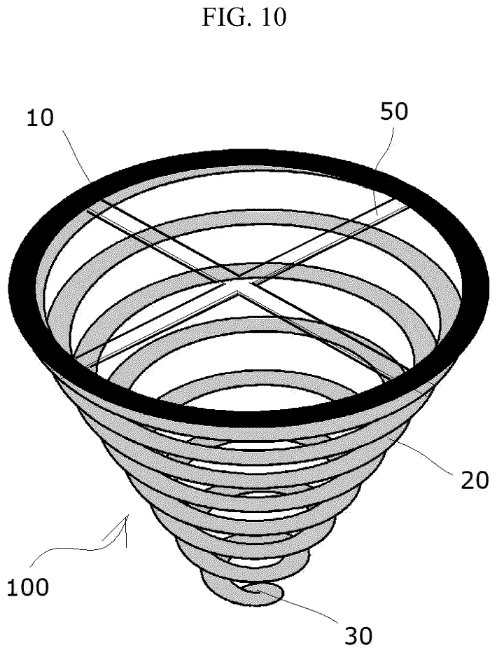

FIGS. 9 and 10 illustrate a third embodiment of the present invention, in which at least one adhesive band 50 is formed in a diameter direction of the water flow guiding band 20.

The adhesive band 50 prevents the water flow guiding band 20 from unraveling before the water flow guiding band 20 unfolds in the stepped form. The adhesive band 50 is provided to address the issue of the water flow guiding band 20 with the narrow width which is continuously cut inward and is difficult to maintain an aligned state.

In other words, the water flow guiding band 20 is made of paper material in order to prevent the problems that it is difficult to pack the water flow guiding band while maintaining the circular shape due to the inwardly continuous cut design of the water flow guiding band with the narrow width and the continuously cut band with the narrow width is tangled when removed from wrapping paper.

Accordingly, the adhesive band 50 is aligned to be horizontally crossed to the diameter direction, preferably, vertical direction of the water flow guiding band 20 with the narrow width, thus addressing the issues that the water flow guiding band 20 does not maintain the circular shape and is tangled.

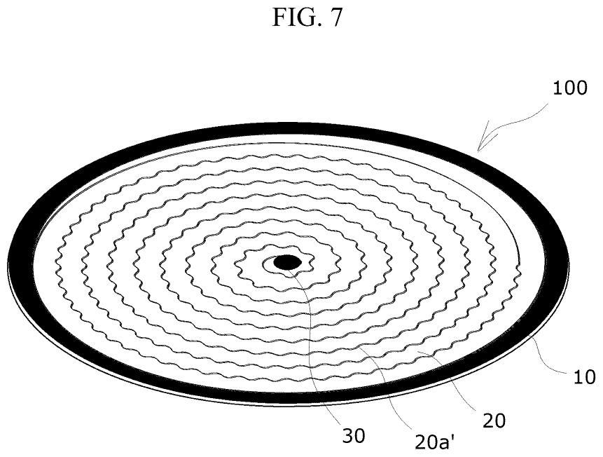

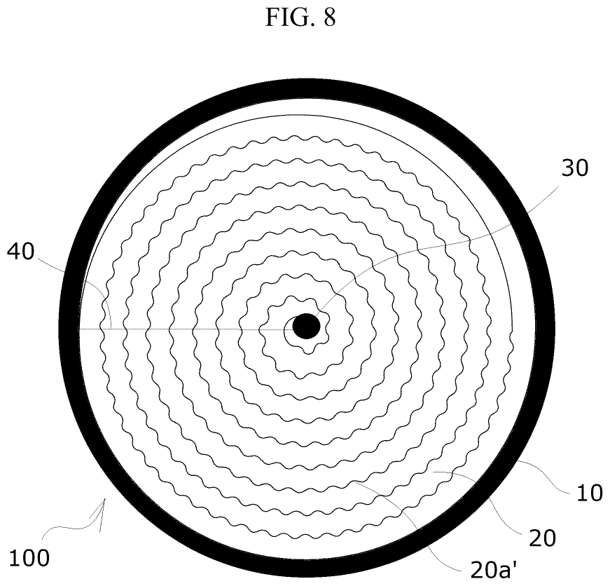

In this instance, the adhesive band 50 may be a starch-based tape that dissolves when coffee powder is placed thereon or an elastic silicone thread that stretches depending on the weight of the coffee powder when the water flow guiding band 20 unfolds in the stepped form. Hereinafter, the same components as FIGS. 1 to 8 are marked with the same reference numerals, and redundant descriptions will be omitted.

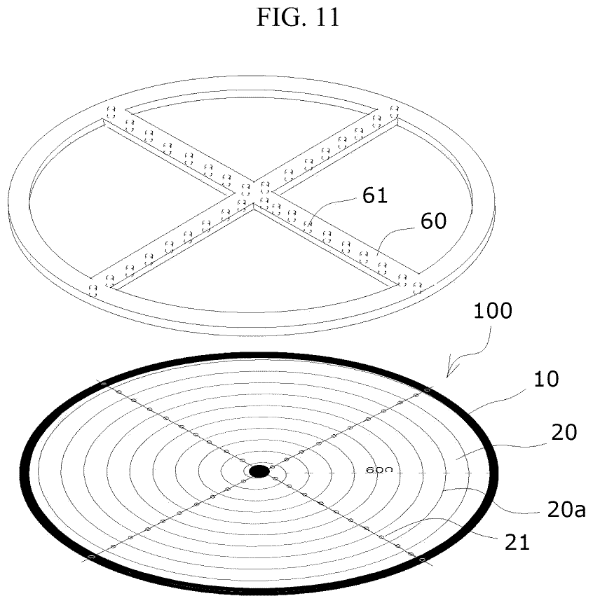

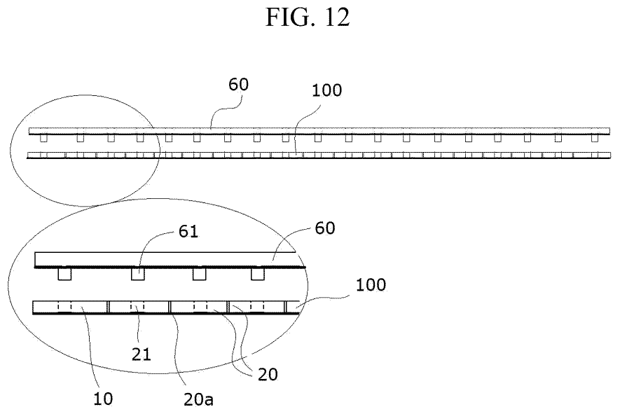

FIGS. 11 and 12 illustrate a fourth embodiment of the present invention, in which the mounting-type fixing ring 10 includes a horizontal band 60 intersecting a circular frame as a basic frame. Additionally, the horizontal band 60 has anti-unraveling fixing pins 61 protruding on the lower portion of the horizontal band 60 at predetermined intervals. The water flow guiding band 20 includes pin coupling holes 21 corresponding to the unraveling fixing pins 61 protruding on the lower portion of the horizontal band 60.

In the fourth embodiment, the unraveling fixing pins 61 protruding from the lower portion of the horizontal band 60 are inserted into the pin coupling holes 21 formed in the water flow guiding band 20 to allow the water flow guiding band 20 to maintain the circular shape before unfolding in the stepped form, thus preventing the water flow guiding band 20 from tangling. the same components as FIGS. 1 to 10 are marked with the same reference numerals, and redundant descriptions will be omitted.

### INDUSTRIAL APPLICABILITY

Although the technical concept of the coffee hand drip guide structure of the present invention has been described with reference to the attached drawings, it should be understood that this is merely an exemplary explanation of the preferred embodiment of the present invention and does not limit the scope of the present invention.

Therefore, the present invention is not limited to the specific embodiments described above, and various modifications and equivalents can be made by those skilled in the art without departing from the gist of the present invention claimed in the claims, and such modifications, and equivalents belong to the claims of the present invention.

1. A guide structure for hand drip coffee which is a circular or elliptical ring tool member stacked on a drip filter inserted into a dripper placed on top of a pot, where coffee powder is introduced therein, comprising:
a mounting-type fixing ring positioned over the top of the dripper; and
a water flow guiding band extending from the mounting-type fixing ring, and depending on the weight of the introduced coffee powder, unfolding in a stepped form and adhering spirally to the inner surface of the drip filter.

2. The guide structure for hand drip coffee according to claim 1, wherein a sagging weight is formed at the inner center of the water flow guiding band to guide unfolding of the water flow guiding band.

3. The guide structure for hand drip coffee according to claim 1, wherein the water flow guiding band unfolds in a stepped form by a cutting line continuously formed in a concentric, regular curved shape inside the mounting-type fixing ring and provides a water flow passage being in close contact with the inner surface of the drip filter.

4. The guide structure for hand drip coffee according to claim 1, wherein the water flow guiding band unfolds in a stepped form by the cutting line continuously formed in an irregular wave-shaped curve to be cut in a wave-shaped or sawtooth-shaped extension line and provides a water flow passage being in partial contact with the inner surface of the drip filter.

5. The guide structure for hand drip coffee according to claim 1, wherein a measuring part is formed on the surface of the water flow guiding band to measure the amount of coffee powder introduced into the drip filter without using a scale.

6. The guide structure for hand drip coffee according to claim 5, wherein the measuring part is numerical indicators or measurement units.

7. The guide structure for hand drip coffee according to claim 1, wherein the water flow guiding band is made of any one of paper and plastic material with a predetermined thickness, is continuously cut in a spiral shape, and has a coil shape maintaining a consistent width when unfolded in a stepped form.

8. The guide structure for hand drip coffee according to claim 1, wherein at least one adhesive band is formed in the diameter direction of the water flow guiding band to prevent unraveling before the stepped unfolding is performed.

9. The guide structure for hand drip coffee according to claim 8, wherein the adhesive band is adhered and fixed in an intersecting manner in the horizontal direction to the vertical direction of the water flow guiding band.

10. The guide structure for hand drip coffee according to claim 8, wherein the adhesive band is a starch-based tape that loses adhesion under the weight of the introduced coffee powder.

11. The guide structure for hand drip coffee according to claim 8, wherein the adhesive band is an elastic silicone thread that stretches when the water flow guiding band unfolds in the stepped form under the weight of the introduced coffee powder.

12. The guide structure for hand drip coffee according to claim 1, wherein the mounting-type fixing ring includes a horizontal band intersecting a circular frame as a basic frame, and the horizontal band has anti-unraveling fixing pins protruding on the lower portion of the horizontal band.

13. The guide structure for hand drip coffee according to claim 12, wherein the water flow guiding band includes pin coupling holes corresponding to the anti-unraveling fixing pins protruding from the lower portion of the horizontal band.
